(19) United States
(12) Patent Application Publication
(10) Pub. No.: US 2017/0009882 A1
(43) Pub. Date: Jan. 12, 2017

(54) PISTON DEVICE, METHOD FOR THE PRODUCTION OF SUCH A PISTON DEVICE AND PISTON CYLINDER UNIT COMPRISING SUCH A PISTON DEVICE

(71) Applicant: SUSPA GmbH, Altdorf (DE)

(72) Inventor: Gerhard WUNDERLING, Pegnitz (DE)

(21) Appl. No.: 15/204,376

(22) Filed: Jul. 7, 2016

(30) Foreign Application Priority Data
Jul. 9, 2015 (DE) 10 2015 212 860.1

(51) Int. Cl. F16J 1/12

(52) U.S. Cl. CPC F16J 1/12

(57) ABSTRACT

A piston device for a piston cylinder unit comprises a rod and a piston which is secured by means of plastic forming onto the rod.

### CROSS-REFERENCE TO RELATED APPLICATIONS

This application claims the priority of German Patent Application Serial No. 10 2015 212 860.1, filed on Jul. 9, 2015, pursuant to 35 U.S.C. 119(a)-(d), the content of which is incorporated herein by reference in its entirety as if fully set forth herein.

### FIELD OF THE INVENTION

The invention relates to a piston device, a method for producing such a piston device as well as a piston cylinder unit comprising such a piston device.

### BACKGROUND OF THE INVENTION

A piston cylinder unit is used for damping linear movements for example.

Thus a piston can be displaced in a housing with damping. The displacement of the pistons can be performed by means of a rod, which projects from the housing.

### SUMMARY OF THE INVENTION

An objective of the invention is to improve the structure of a piston cylinder unit.

The objective is achieved by a piston device for a piston cylinder unit comprising a rod and a piston, wherein the piston is fixed onto the rod by means of plastic forming, by a method for the production of a piston device according to the invention comprising the method steps of providing a rod and a piston, and plastically forming the piston for fixing onto the rod, and by a piston cylinder unit comprising a piston device according to the invention. The gist of the invention is that a piston is secured onto a rod by means of plastic forming. Such a piston device is well suited for use in a piston cylinder unit, in particular a gas spring and in particular a lockable gas spring. The piston device can also be used for non-lockable gas compression springs and/or for shock absorbers. The piston is joined to the rod. The joining process is performed without machining The forming of the piston results in an inherent increase in strength. By means of the plastic deformation it is possible to increase the hardness of the material. This means that the piston device with the plastically formed piston can have an increased material strength compared to the unformed piston. The piston device is robust and enables loading with increased traction and pressure forces of up to 130% compared to a piston device according to the prior art. The load-bearing ability of the piston device according to the invention is increased. The joining of the piston to the piston rod by plastic forming makes it possible to allow generous dimensional tolerances. The piston device can be produced by automated processes. The piston device can be produced economically, in particular in large quantities.

A piston device in which the piston is pressed onto the rod, and in particular is pressed radially, makes the production process uncomplicated. The piston can be pushed onto the rod for example and can then be joined to the rod by radial pressing. As in particular the piston and/or the rod are designed to be radially symmetrical relative to a piston longitudinal axis, a rotational orientation of the piston relative to the rod is unproblematic. The radial pressing can be performed in every rotational position of the piston relative to the rod. It is also possible for a preferred arrangement to be defined relative to the rotational angle, which can be taken into consideration accordingly.

A piston device, in which the rod comprises at least one undercut element, with which a pressing section of the piston cooperates, guarantees axial securing along the piston longitudinal axis of the piston device. The at least one undercut element makes it possible to grip behind the rod along the piston longitudinal axis. The pressing section of the piston is provided in particular on the undercut element.

A piston device in which the undercut element is designed as a peripheral outer groove on the rod enables an uncomplicated production process. An external groove can be produced by automated processes.

A piston device in which the piston is designed to be sleeve-like, at least in the area of the pressing section, simplifies the radial pressing. The piston can be pushed onto the rod so that the piston surrounds the rod at least in some sections. In the not yet pressed state the piston can be arranged stably and reliably on the rod. The following joining step, the plastic forming, can be performed reliably with defined boundary conditions.

A piston device with a plurality of undercut elements, wherein a holding ring is arranged along the longitudinal axis between two adjacent undercut elements, ensures the increased strength of the joining connection. The holding ring is designed as a radially projecting web between two undercut elements. In this way the strength of the connection between the piston and rod is additionally increased. The pulling off forces necessary to release the piston from the rod are increased.

A piston device in which the holding ring comprises an flank surface facing an undercut element respectively, the flank surface forming an obtuse angle with the respective undercut element, in particular the groove base, results in a further increase of the pulling off forces.

A piston device, in which the piston has a disc section, on which in particular a recess is provided for a sealing element, enables the sealed displacement of the piston device in a piston cylinder unit. The sealing element is designed in particular for radially sealing an inner surface of a housing of the piston cylinder unit. The disc section is formed in particular to be integral with the piston.

With a piston device in which the piston is made from a cold formable material the joining can be facilitated by plastic forming In particular, the piston is made from a wrought aluminium alloy, in particular from EN AW 2011, or steel, in particular machining steel or Q & T steel. In particular, the piston is made in one piece.

A method for the production of a piston device comprises the method step of providing a rod and a piston and performing the plastic shaping of piston for fixing to the rod. The method is uncomplicated and can be performed by automated processes. The method is economical.

A method in which the forming comprises radial pressing simplifies the production of the piston device.

A method, in which the forming is performed at ambient temperature, makes the additional heating of the joining elements unnecessary. The power used to produce the piston device is reduced. The cycle time is reduced. The method is uncomplicated and particularly economical. Additional tools are unnecessary. Heating and cooling times are not required.

A piston cylinder unit comprising a piston device essentially has the advantages which are referred to here.

Further advantageous embodiments, additional features and details of the invention are given in the following description of an example embodiment with reference to the drawing.

### BRIEF DESCRIPTION OF THE DRAWING

FIG. 1 shows a longitudinal cross-section of a piston cylinder unit according to the invention,

FIG. 2 shows an enlarged longitudinal cross section of a piston device according to the invention,

FIG. 3 shows a side view of the piston device according to FIG. 2,

FIG. 4 shows a side view of the rod of the piston device according to FIG. 3,

FIG. 5 shows a side view of the piston of the piston device according to FIG. 3 and

FIG. 6 shows a longitudinal cross-section along the section line VI-VI in FIG. 5.

### DESCRIPTION OF THE PREFERRED EMBODIMENT

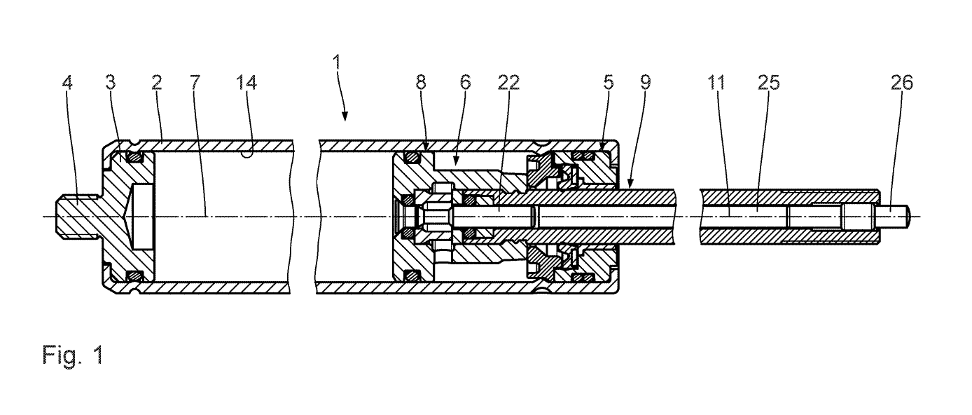

A piston cylinder unit 1 shown in FIG. 1 comprises an essentially cylindrical housing 2, which is closed at a first end, shown on the left in FIG. 1, by means of a closure element 3. The closure element 3 has a one-piece screw pin 4, onto which a securing element can be screwed. A guiding/sealing unit 5 is provided at an end arranged opposite the closure element 3 in the housing 2. The guiding/sealing unit 5 is used for the guided displacement of a piston device 6 along a longitudinal axis 7 of the housing 2. The piston device 6 comprises a piston 8 which is secured onto a rod 9. The rod 9 is guided out of the housing 2 in a sealed manner by the guiding /sealing unit 5. The piston device 6 is arranged with a piston longitudinal axis 11 to be concentric to the longitudinal axis 7 of the housing 2 in the piston cylinder unit 1.

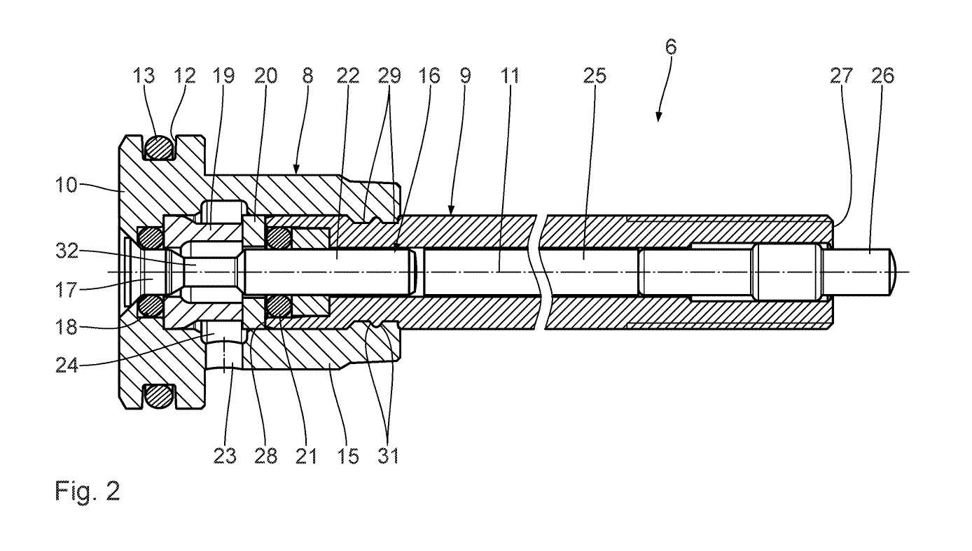

In the following the piston device 6 is explained in more detail with reference to FIGS. 2 to 6. The piston 8 is made from the wrought aluminium alloy EN AW 2011. The piston 8 is designed in one piece and has a disc section 10. The disc section 10 extends from a front edge face facing the closure element 3, shown on the left in FIG. 2, along the piston longitudinal axis 11. he piston 8 is designed to be rotationally symmetrical relative to the piston longitudinal axis 11. On the disc section 10 an externally circumferential recess 12 is provided into which a sealing element 13 is inserted in the form of an O ring. By means of the sealing element 13 the piston 8 bears on an inner surface 14 of the housing 2 in a sealing manner

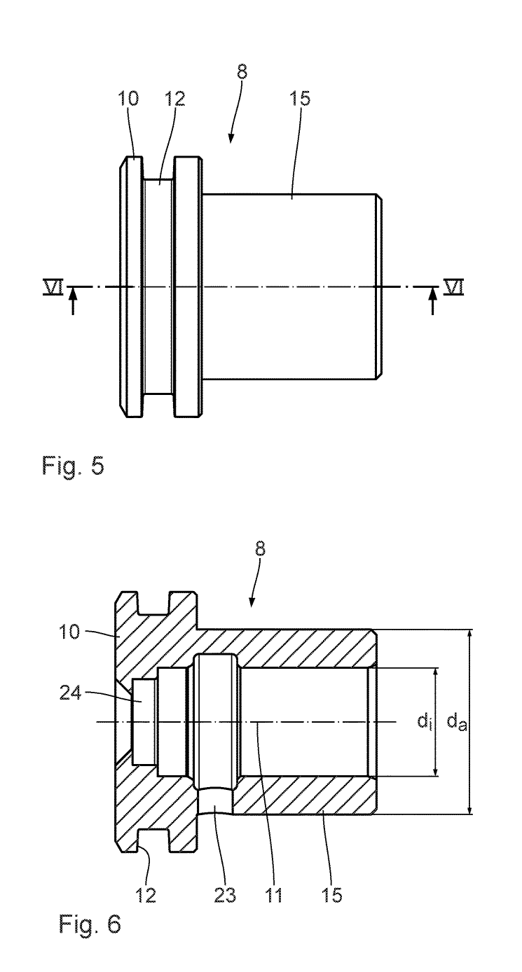

The piston 8 has a sleeve-like pressing section 15. In a plane perpendicular to the piston longitudinal axis 11 the pressing section is designed to be annular and in the unpressed starting position according to FIG. 5, 6 has in particular an invariable inner diameter dᵢ along the piston longitudinal axis 11 and in particular an invariable external diameter dₐ along the piston longitudinal axis 11.

The piston cylinder unit 1 according to FIG. 1 is a lockable gas compression spring. The piston device 6 also comprises an activatable valve unit 16. The valve unit 16 is guided concentrically to the piston longitudinal axis 11 through the piston rod 9 and the piston 8. The valve unit 16 comprises a valve pin 17 facing the end face of the disc section 10, which is sealed from the inner side of the piston 8 by means of a first inner seal 18. The first inner seal 18 is supported by means of a damping element 19 and a support disc 20 on the end side of the rod 9.

The valve pin 17 is formed in one piece on a valve rod 22. The valve rod 22 is sealed by means of a second inner seal 21 from the piston device 6, in particular the rod 9. The piston 8 comprises a transverse bore 23 which allows fluid to flow through a central inner bore 24. Along the piston longitudinal axis 11 adjacent to the valve rod 22 an activating rod 25 and a triggering element 26 are provided. The triggering element 26 projects over a rear end side 27 of the rod 9. To activate the valve unit 16 the triggering element 26 is activated along the piston longitudinal axis 11, i.e. pushed inside the rod 9. Said axial force is transmitted by the triggering element 26 via the activating rod 25 to the valve rod 22. The valve pin 17 designed in one piece with the valve rod 22 is displaced to the left according to FIG. 2 until a rod section 32 thinner than the valve pin 17 is arranged on the first inner seal. In this triggered arrangement the flow channel formed by the transverse bore 23 and the inner bore 24 is released. Fluid can flow through the piston device 6 between two operating chambers in the housing 2.

FIG. 2 shows the inactivated arrangement of the valve unit 16. In this arrangement the valve pin 17 lies in a sealing manner on the first inner seal 18. Fluid is prevented from flowing along the transverse bore 23 and the inner bore 24.

The rod 9 is designed to be essentially hollow cylindrical. At an end facing the piston 8 spaced apart from the front end face 28 two undercut elements 29 are provided. It is also possible to provide more than two undercut elements 29 along the piston longitudinal axis 11, wherein in particular two adjacent undercut elements 29 are always separated from one another by a holding ring 30. The undercut elements 29 are designed respectively as an circumferential external groove on the rod 9. The two undercut elements 29 are arranged adjacent to one another along the piston longitudinal axis 11 and are separated from one another by a holding ring 30. The holding ring 30 is designed to project radially relative to the external groves. The holding ring 30 has flank surfaces 31 designed to be oblique, which form an obtuse angle w with the respective groove base of the undercut elements 29. The obtuse angle w is greater than 90° and smaller than 180°. In particular, the obtuse angle w is more than 95° and less than 160°, in particular more than 105° and less than 135° and in particular between 110° and 120°.

The rod 9 comprises in the region of the undercut elements a first internal diameter d1 which is defined by the external groove. A second external diameter d2 is defined by the holding ring 30. Here d_{2>}d₁.

In the following the method for the production of the piston device 6 is explained in more detail. Starting with the undeformed initial state of the piston 8 according to FIG. 5, 6 the latter is pushed onto the rod 9 along the piston longitudinal axis 11 with the sleeve-like pressing section 15 on the front end face 28. The pressing section 15 surrounds the undercut elements 29 along the outer circumference. As the internal diameter dᵢ is greater than the first external diameter dᵢ and the second external diameter d₂ of the rod 9, the pressing section 15 is arranged spaced apart radially from the undercut elements 29. It is possible that the second external diameter d₂ corresponds essentially to the internal diameter dᵢ.

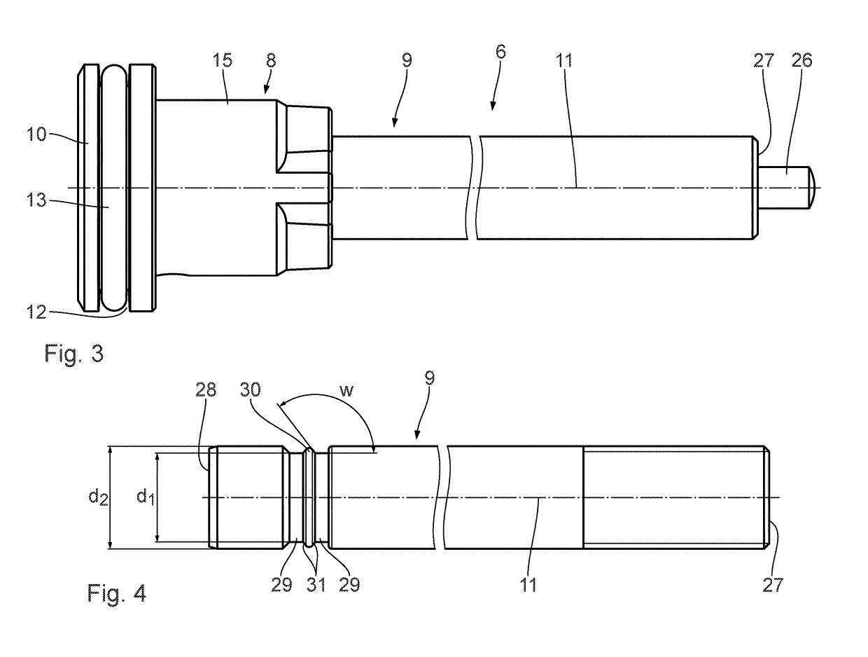

In the pushed on position of the piston 8 on the rod 9 the piston 8 is joined to the rod 9 to form the piston device 6 according to FIG. 2, in that the piston 8 is pressed by the rod, in particular in the region of the pressing section 15. By means of a not shown pressing tool the pressing section 15 of the piston 8 is pressed in radially relative to the piston longitudinal axis 11. Material of the pressing section 15 of the piston 8 is deformed plastically and pressed into the undercut elements 2. The pressed state of the piston 8 is shown in FIGS. 2 and 3. This produces in particular a fully circumferential undercut of material of the pressing section 15 in the undercut elements 29. The piston 8 is held reliably and securely on the rod 9. After the pressing process the piston 8 has a non-round external contour in the area of the pressing section 15. By means of the pressing process the external diameter d_{a′} of the piston 8 is reduced after the pressing at least partly. The inner diameter d_{i′} of the piston 8 is reduced after pressing in the region of the undercut elements 29 and the holding ring 30.

The pressing is performed at ambient temperature.

What is claimed is:

1. A piston device for a piston cylinder unit comprising a rod and a piston, wherein the piston is fixed onto the rod by means of plastic forming.

2. A piston device according to claim 1, wherein the piston is pressed onto the rod.

3. A piston device according to claim 1, wherein the rod comprises at least one undercut element, with which a pressing section of the piston cooperates.

4. A piston device according to claim 3, wherein the undercut element is formed as a peripheral external groove on the rod.

5. A piston device according to claim 3, wherein the piston is designed to be sleeve-like at least in the region of the pressing section.

6. A piston device according to claim 3, wherein the rod comprises at least another undercut element to provide a plurality of undercut elements, wherein a holding ring is arranged along a piston longitudinal axis between two adjacent undercut elements.

7. A piston device according to claim 6, wherein the holding ring comprises a flank surface facing one of the undercut elements, wherein the flank surface forms an obtuse angle with a respective undercut element.

8. A piston device according to claim 7, wherein the flank surface forms an obtuse angle with the groove base.

9. A piston device according to claim 1, wherein the piston has a disc section.

10. A piston device according to claim 9, wherein a recess for a sealing element is provided on the disc section.

11. A piston device according to claim 1, wherein the piston is made from one of a cold-formed material and steel.

12. A piston device according to claim 11, wherein the cold-formed material is a wrought aluminum alloy and the steel is a machining steel.

13. A piston device according to claim 12, wherein the wrought aluminum alloy is EN AW 2011 and the machining steel is Q and T steel.

14. A method for production of a piston device for a piston cylinder unit, the method comprising the method steps:
providing a rod and a piston, plastically forming the piston for fixing onto the rod.

15. A method according to claim 14, wherein the forming comprises radial pressing.

16. A method according to claim 14, wherein the forming is carried out at ambient temperature.

17. A piston cylinder unit comprising:
a piston device comprising a rod and a piston, wherein the piston is fixed onto the rod by means of plastic forming
